(19) United States
(12) Patent Application Publication
(10) Pub. No.: US 2026/0298026 A1
(43) Pub. Date: Oct. 1, 2026

(54) LADDER MOUNTABLE PAINT CAN HOLDER

(71) Applicant: Roger A. May, Kentwood, MI (US)

(72) Inventor: Roger A. May, Kentwood, MI (US)

(21) Appl. No.: 19/574,229

(22) Filed: Mar. 20, 2026

Related U.S. Application Data
(60) Provisional application No. 63/779,113, filed on Mar. 27, 2025.

(51) Int. Cl. E06C 7/14

(52) U.S. Cl. CPC E06C 7/14

(57) ABSTRACT

A ladder mountable paint can or container holder other with an angle adjustable standoff arm which prevents a paint can or other container from swinging into lower ladder rungs or steps and holds the container in a level position for use by the worker using the contents of the container. Interconnected downwardly opening step engaging and embracing channel engaging an upper step and an upwardly opening channel engaging and embracing channel engaging and embracing a lower step from beneath prevent the mounted paint can holder from being accidently disengaged from the ladder. In an alternative embodiment, a downwardly opening step engaging and embracing channel engaging and embracing a upper step which is interconnected to downwardly extending parallel legs which trap a lower step between them and extend a sufficient distance below the trapped step to prevent its being accidentally being jarred upwardly and out from between said downwardly entrapping legs and becoming disengaged from the ladder.

### BACKGROUND OF THE INVENTION

The present invention relates to ladder mounted paint can holders which are attached or can be attached to a ladder for holding paint cans or other holders in place on a ladder within easy reach of a painter or other person to access and use the paint or work with objects being held in the container. Such holders are of the following types:
The standard fold down platform which is part of the ladder for setting paint cans and other objects on when it is folded down;
Ladder step extenders which extend out to the side of the ladder for hanging paint can handles over or for engaging with intermediate hooks for paint cans or other work support objects to;
Clamps which can be clamped to the side or a rung of the ladder, and are configured to support paint cans or the like.

Or combinations of the forgoing.

### BRIEF DESCRIPTION OF THE DRAWINGS

FIG. 1 is a perspective view of the holder mounted on a ladder while carrying a paint can;

FIG. 2 is a perspective view of the two separate components of the holder;

FIG. 3 is a perspective view illustrating the way a user can move a ladder with the holder carrying a paint can or the like without having to remove the holder from the ladder or worry the holder and its load being jarred off of the ladder; and

FIG. 4 is a perspective view of an alternative embodiment of the invention.

### IDENTIFICATION OF COMPONENTS SHOWN IN THE DRAWINGS

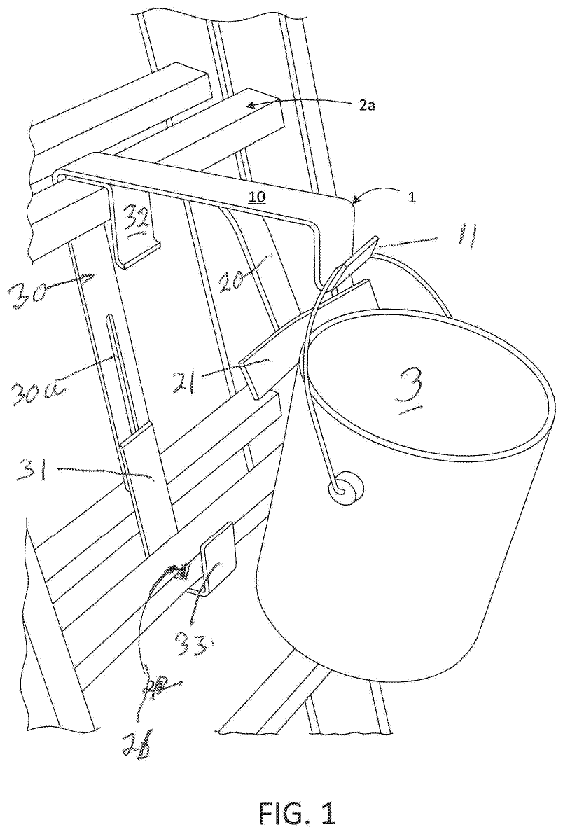

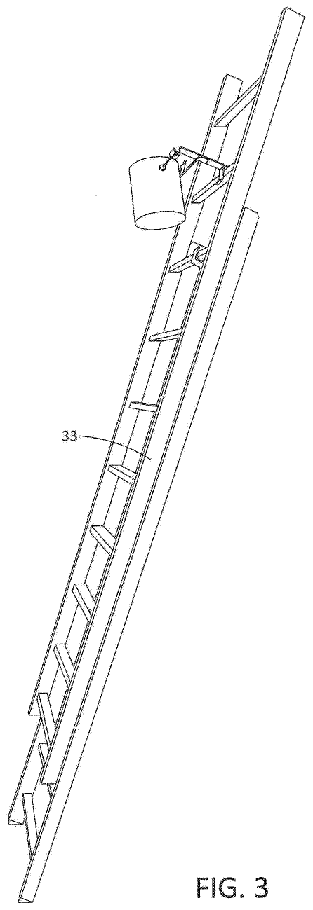

FIGS. 1-3
mountable container holder 1
ladder 2
ladder steps 2a
container 3
outward extending holder arm 10
downwardly extending vertical leg 30
downwardly extending forward channel wall
container supporting hook 11
adjustable angle standoff arm 20 (angle is adjustable as a function of angle of the ladder to center of gravity/set up angle to building)
lateral container cradle arm 21
adjustment slot 30a
adjustment bolt 31a
lower vertical leg extension 31
lower ladder step embracing channel 33.

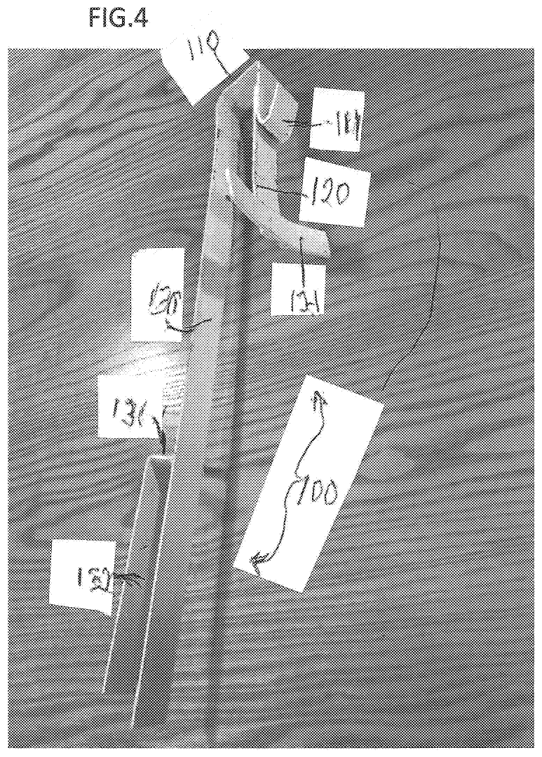

FIG. 4
Alternative embodiment mountable container holder 100
Upper ladder horizontal leg 110 of step embracing channel
Container supporting hook 111
Adjustable standoff arm and forward downwardly step embracing channel leg 120
lateral container cradle arm 121
downwardly extending back leg 130
horizontal and rearwardly extending top leg 131 of rearwardly extending step embracing long channel
Rear downwardly extending long leg of step embracing long channel.

### WRITTEN DESCRIPTION OF THE PREFERRED EMBODIMENTS

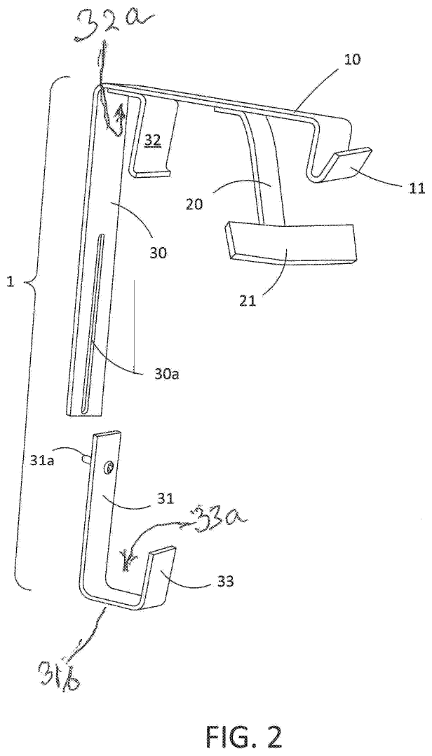

In the preferred embodiment, the present invention comprises a ladder mountable paint can or container holder 1 with an outwardly extending hook arm 10 which extends outwardly about 9 to about 10 inches from a rear downwardly extending adjustable leg 30, 31. A downwardly extending short leg 32 depends about 1.5 to about 2 inches from hook arm 10, and with hook arm 10 and back leg 30, 31 forms an upper step embracing downwardly opening channel 32a. The width of channel 32a must be just wide enough to accommodate the width of a step 2a of the ladder 2 for which mountable container holder 1 is being designed. While this width might vary depending on the ladder, the typical ladder has steps which are about 1.5-2.5 inches wide. As a downwardly opening channel, channel 32a sits down on top of and embraces a step 2a from above. Hook arm 10 extends beyond downwardly extending leg 32, and beyond its juncture at about 5 to about 6 inches with a downwardly depending forwardly curving and adjustable standoff arm 20, with hook arm 10 terminating in a container holding hook 11 for holding a paint can such as can 3 shown in FIG. 1. Hook 11 extends downwardly about 2-3 inches and then is bent back upwardly about an inch. The downwardly and forwardly slightly curving standoff arm 20 extends downwardly about 4-5 inches where it is connected to a laterally slightly curved paint can cradling arm 21, which extends about 2-4 inches to either side of its junction with the end of standoff arm 20. inches a. Standoff arm 20 performs the function of preventing container 3 from swinging into lower ladder steps and is sufficiently manually bendable to be adjustable to a position which holds container 3 in a level position for use by the worker using the contents of the container. (FIGS. 1 and 2).

Vertical back leg 30,31 is comprised of an upper leg 30 and a separate lower leg 31. Upper leg 30 is about 10 inches long and includes a length adjustment slot 30a which extends about 6 inches to the bottom end of upper leg 30. Lower leg 31 has a length of about 6 inches and is connected to upper leg 30 by an adjustment bolt 30b which until tightened slides in slot 30a. Lower leg 31 is bent into a forwardly extending bottom channel wall 31b, which in turn is bent into a short upwardly extending front channel wall 33. The lower part of lower leg 31, the bottom forwardly extending wall 31b and the upwardly extending channel wall 33 form a lower ladder step embracing channel 33a. While upper step embracing channel 32a opens downwardly to embrace a step 2a from above, bottom step embracing channel 33a opens upwardly to embrace a ladder step 2b from below. The container holder 1 is thus locked on the ladder between upper step 2a and lower step 2b. The position of lower ladder step embracing channel 33a can be adjusted by sliding adjustment bolt 30b and leg extension 31 up or down in leg extension slot 30a as required, in order to bring ladder step embracing channel 33a up from beneath and engages and embraces step 2b. One then tightens bolt 30b, thus preventing holder 1 from being accidentally disengaged from ladder 2. (ibid)

Mountable holder 1 is preferably made of a sturdy rigid material which will resist breakage or collapse under the weight of use. Steel or rigid structural plastic will work, though steel which is sufficiently thin to be bendable, especially in the standoff arm 20 is preferred. A steel thickness of about 1/16 inch to about 3/16 inch is preferable. The width of the steel used is about ¾ inch to 2¼ inch is preferred. The width of the steel used must be balanced against the thickness for bendability of standoff arm 20. A steel width of 1 inch and thickness of ⅛ inch is workable.

### Alternative Embodiment

Alternative embodiment ladder mountable container holder 100 is more compact and light weight in structure, uniquely combining parts and functions (FIG. 4). It comprises an upper horizontal leg 110 which is bent from a downwardly extending back leg and extends forwardly just a sufficient distance to form the base leg of a channel wide enough to fit over and embrace the width of a ladder step. From there it is bent downwardly and extends for a short distance of about 2-3 inches and then is bent back upwardly about an inch to form a hook 111 for hanging a paint can or other container from. A standoff arm 120 extends downwardly from directly beneath hook 111 about 4-5 inches and is curved slightly forwardly terminating in a laterally extending container cradle arm 121 which extends about 2-4 inches to either side of its junction with the end of standoff arm 120. Standoff arm 120 performs the function of preventing container 3 from swinging into lower ladder steps and is sufficiently manually bendable to be adjustable to a position which holds container 3 in a level position for use by the worker using the contents of the container.

One advantage to using an upper horizontal leg 110 which is just wide enough to serve as the base leg of a step embracing channel and bending it straight down about 2-3 inches and then is bent back upwardly about an inch to form a hook 111 for hanging a paint can is that it keeps the open and suspended paint can closer to the surface which the paint is being applied to and further from the body of the painter and thus easier for the painter to reach out to use with a straighter arm.

Back leg 130 extends straight downwardly about 18-20 inches. At a distance just a little less than the distance between ladder steps (typically 12-14 inches), horizontal leg 131 extends rearwardly for a distance about which is the width of a ladder step. It then bends straight downwardly as leg 132 such that it is parallel to leg 130 and terminates approximately across from the end of leg 131. Accordingly, the distance between leg 132 and 130 is the same as the width of a ladder step. The lengths of leg 130, 131 and 132 that the paint can holder 100 can be mounted to the ladder by lowering it over an upper step with rear leg 130 behind the step and standoff leg in front of it, and continue lowering it until top channel leg 110 is seated on the upper step and a lower ladder step is located between parallel legs 130 and 132. For security that the mounted paint can holder 100 will not be accidentally jarred free of the ladder, it is preferable that legs 130 and 132 extend several inches below the level of the lower ladder step which they embrace. Thus, for a ladder whose Steps are 12 inches apart, it is preferable that the rearwardly extending leg be located at about 10 inches down from the top of leg 130. Then in a mount 100 where legs 130 extend to 19 inches, the lower ladder step trapped between parallel legs 130 and 132 at 12 inches will still be trapped between them for 7 more inches.

Thus, whereas the first embodiment can holder 1 relies on trapping upper and lower ladder steps between an upper downwardly opening channel and lower upwardly opening channel to secure the mount, which requires the use of two different channel members and slidable adjustment between them, the alternative embodiment mount 100 achieves security by using only a downwardly opening upper channel and a lower elongated channel which traps the lower step between the downwardly extending legs of a channel for a substantial distance below the level of the lower step.

1. A ladder mountable paint can or container holder with an angle adjustable standoff arm which prevents a paint can or other container from swinging into lower ladder rungs or steps.

2. The ladder mountable paint can or container holder of claim 1 in which said angle adjustable standoff also holds the container in a level position for use by the worker using the contents of the container.

3. The ladder mountable paint can or container holder of claim 2 has interconnected downwardly opening and upwardly opening step engaging and embracing channels for engaging and embracing an upper step from above and a lower step from below, respectively to prevent the mounted paint can holder from being accidently disengaged from the ladder.

4. The ladder mountable paint can or container holder of claim 2 in which a downwardly opening step engaging and embracing channel for positioning to engage and embrace an upper ladder step; said channel being interconnected to downwardly extending parallel legs which trap a lower step between them and extend a sufficient distance below the trapped step to prevent its being accidentally jarred upwardly and out from between said downwardly entrapping legs and becoming disengaged from said ladder.

5. A method of using a ladder mountable paint can or container holder with an angle adjustable standoff arm to prevent a paint can or other container from swinging into lower ladder rungs or steps.
